(19) United States
(12) Patent Application Publication
(10) Pub. No.: US 2007/0152192 A1
(43) Pub. Date: Jul. 5, 2007

(54) PRECONSTRUCTION ORGANIC ZINC PRIMER AND METHOD FOR PRODUCTION AND APPLICATION

(76) Inventor: Mike KIRK, Gladstone, MO (US)

Correspondence Address: SPENCER, FANE, BRITT & BROWNE, 1000 WALNUT STREET, SUITE 1400, KANSAS CITY, MO, 64106-2140, US

(21) Appl. No.: 11/620,366

(22) Filed: Jan. 5, 2007

Related U.S. Application Data
(60) Provisional application No. 60/756,330, filed on Jan. 5, 2006.

(51) Int. Cl. C09K 3/00; C08K 3/08

(52) U.S. Cl. 252/389.52; 524/439

(57) ABSTRACT

A zinc-rich preconstruction primer coating composition includes zinc powder dispersed in a polyurethane vehicle to which is added a curing catalyst to produce a moisture cured extended durability coating that is weldable. The zinc-rich preconstruction primer coating composition is applied by sprayer to preheated metal panel stock moving along a conveyor line, after which, the coated panel moves through an oven section where it is subjected to a water mist to effect curing of the coating.

### CROSS REFERENCE TO RELATED APPLICATIONS

This Application is related to earlier-filed Provisional Application Ser. No. 60/756,330, filed Jan. 5, 2006. The identified earlier-filed application is hereby incorporated by reference into the present Application.

### BACKGROUND OF THE INVENTION

Zinc based metal primers often have characteristics that limit their utility, such as relatively long curing times, high curing temperatures, or relatively short term durability. In other examples of zinc based primers, relatively thick coatings are produced which either lose effectiveness upon welding of the metal to which they are applied, or interfere with the welding process and the resulting strength and integrity of the welds. Common silicate based zinc primers, which are weldable, have the disadvantage of not being suitable for coating metal construction materials intended for use in applications where toxicity is a concern, such as in connection with potable water applications.

Accordingly, it is desirable to provide a zinc based metal primer composition and a method of preparation and application that will result in relatively rapid cure at moderate temperature in a substantially continuous process, to produce a thin film coating with long term durability while retaining effectiveness upon welding of the metal to which it is applied without interfering with the weldability of the metal, to provide metal construction materials capable of constructing large welded structures such as water tanks suitable for storage of potable water.

### BRIEF SUMMARY OF THE INVENTION

There is, therefore, provided in the practice of the invention a zinc-rich preconstruction primer coating composition and a method for preparing the finished primer and applying it in thin films to steel and other metal construction materials in a substantially continuous manner, comprising zinc powder dispersed in a reactive polyurethane binder vehicle composition to which is added a curing catalyst to produce a moisture cured extended durability coating that retains effectiveness upon welding of the metal construction materials and does not interfere with weldability of such materials. The preconstruction primer coating composition may be a three-part system where the zinc powder, the reactive polyurethane binder vehicle composition, and the curing catalyst are packaged in separate containers and are combined together a short time prior to application to the metal surface.

In accordance with one embodiment, the invention comprises a polyurethane zinc-rich preconstruction primer that produces a weldable organic film, which can be NSF (National Sanitation Foundation) certified for use in potable water tank applications. The preconstruction primer composition comprises at least about 51% by weight zinc powder and a urethane pre-polymer having a plurality of reactive isocyanate groups. A curing catalyst comprising a combination of organo-tin and polyamine catalysts in an aromatic hydrocarbon and aliphatic ketone solvent system is combined into the composition prior to application to the substrate to be primed. The applied preconstruction primer film is then cured by water reacting with the excess isocyanate groups.

In accordance with still another embodiment of the present invention, a method of production and application of a zinc-rich preconstruction primer coating composition is provided wherein the reactive polyurethane binder vehicle, the zinc powder, and the curing catalyst are combined with sufficient agitation to produce a substantially uniform coating composition, the coating composition is then applied by sprayer to preheated metal construction materials, particularly plate or panel stock, moving along a conveyor line. After coating, the panel moves through another heated section where it is subjected to a water mist to effect rapid curing of the coating. Accordingly, the method is useful in very high humidity environments.

In accordance with another embodiment of the present invention, a method of applying the primer to metal panels is provided wherein the metal panel is placed on a conveyor line whereby the panel passes through a pre-heat oven to raise the temperature of the panel. The panel is then coated by spraying the zinc-rich preconstruction primer coating composition onto the surfaces of the panels to a desired dry film thickness. After coating, the conveyor line moves the panel into a curing oven set at higher temperature. The curing oven also includes a plurality of misting jets through which water is substantially uniformly misted around the panel as it passes through the curing oven to cure the coating.

According to another embodiment of the invention, a primed metal panel suitable for constructing large welded structures such as water tanks suitable for storage of potable water is provided, comprising spray coating of a metal panel in a substantially continuous process with a water cured zinc-rich polyurethane preconstruction primer. Such primed metal panels have excellent corrosion resistance, and are capable of being welded together for construction of large welded structures such as water tanks suitable for storage of potable water in accordance with NSF standards.

Accordingly, it is an object of the present invention to provide an improved zinc-rich primer composition and improved methods of preparation and application. There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of composition and to the arrangements of the components and methods set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other compositions, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE DRAWINGS

Further features of the present invention will become apparent to those skilled in the art to which the present invention relates from reading the following description with reference to the accompanying drawings, in which:

FIG. 1 is a schematic diagram illustrating a spray coating conveyor line according to a preferred embodiment method of the invention.

### DETAILED DESCRIPTION OF THE INVENTION

Certain aspects of the invention will be described with reference to the drawing figures, in which like reference numerals refer to like parts throughout.

An embodiment in accordance with the present invention provides a zinc-rich preconstruction primer coating composition for steel and other metal construction materials and method of production and use, comprising zinc powder dispersed in a reactive polyurethane binder vehicle to which is added a curing catalyst to produce a moisture curable extended durablility coating that is weldable. The preconstruction primer composition may be packaged as a two-part system where a first component includes the zinc powder pre-combined with the reactive polyurethane binder vehicle composition, and a second component includes the curing catalyst and solvent.

In another embodiment of the invention, the preconstruction primer composition is packaged as a three-part system, including about 18% to about 26% by weight of a first component comprising the reactive polyurethane binder vehicle, about 51% to about 71% of a second component comprising the zinc powder, and about 3% to about 31% of a third component comprising the curing catalyst, and wherein the zinc powder and the curing catalyst are sequentially non-reactively combined with the reactive polyurethane binder vehicle a short time prior to application.

The preconstruction primer of the invention comprises a reactive polyurethane binder composition that serves as the primary vehicle for the primer composition; zinc powder which provides corrosion protection to the substrate being coated; a curing catalyst to cause rapid curing of the reactive polyurethane binder by moisture in a temperature range from about 115° F. to about 175° F.; and one or more organic solvents as diluent. The preconstruction primer produces a weldable zinc-rich organic film, which can be NSF certified for use in potable water tank applications. The preconstruction primer composition may be applied to a steel panel by sprayer to produce a moisture cured primed steel panel having excellent atmospheric corrosion resistance and excellent weldability for construction of large potable water tanks.

In an embodiment of the invention the reactive polyurethane binder composition includes about 8% to about 12% by weight, based on total preconstruction primer composition, of a urethane pre-polymer having a plurality of reactive isocyanate groups. The urethane pre-polymers may be derived from aromatic polyisocyanates or aliphatic polyisocyanates, and oligomers thereof. Preferred urethane pre-polymers are based on aromatic diisocyanates such as diphenylmethane diisocyanate and toluene diisocyanate, and oligomers thereof. The reactive polyurethane binder composition may further include one or more additional additives commonly used in coating compositions, including for example, up to about 45% by weight hydrocarbon solvents, up to about 1% by weight dispersing agents, up to about 2% by weight rheology modifiers, up to about 10% by weight inert fillers, and up to about 7% by weight pigments.

The preconstruction primer further includes about 51% to about 71% by weight, based on total preconstruction primer composition, high purity zinc powder having average particle size such that not less than about 99.8% will pass through a 200 mesh sieve and not less than about 98% will pass through a 325 mesh sieve. The zinc powder preferably has a very low lead content, preferably less than about 1.5×10⁻³% by weight as Pb.

A useful reactive urethane binder composition is commercially available from Sherwin Williams as COROTHANE® I, Galvapac Two Pack Zinc Primer, where one component is the moisture curable urethane binder, and a second component is zinc dust.

The preconstruction primer composition further includes a curing catalyst comprising a combination of organo-tin and tertiary amine catalysts dissolved in an organic solvent.

In an embodiment of the invention, the organo-tin catalyst comprises up to about 0.02% by weight dibutyltin dilauryl mercaptide, the tertiary amine catalyst may be a polyamine catalyst comprising up to about 0.25% by weight of triethylene diamine, and the organic solvent comprises a combination of up to about 99.5% by weight aromatic hydrocarbon and up to about 0.5% by weight aliphatic ketone solvents. Other organo-tin catalysts and other tertiary amine catalysts may also be used effectively. In an embodiment of the invention, the curing catalyst includes a solution of about 33% by weight triethylene diamine in about 67% by weight dipropylene glycol in a quantity sufficient to provide the desired amount of triethylene diamine in the preconstruction primer.

In one embodiment, the reactive polyurethane binder composition includes a C-7 to C-9 aromatic hydrocarbon solvent, and the curing catalyst includes a C-7 to C-9 aromatic hydrocarbon solvent and an aliphatic ketone solvent. Xylene and acetylacetone are particularly useful solvents.

In one embodiment of the invention the preconstruction primer comprises a two-component system wherein a first component includes a combination of the reactive polyurethane binder composition and the zinc powder and a second component includes a combination of one or more curing catalysts in C-7 to C-9 aromatic hydrocarbon and aliphatic ketone solvents.

In another embodiment, the preconstruction primer comprises a three-component system wherein the first component includes the reactive polyurethane binder composition, the second component includes the zinc powder, and the third component includes a combination of one or more curing catalysts in C-7 to C-9 aromatic hydrocarbon and aliphatic ketone solvents.

The invention further comprises a method of preparing the zinc-rich preconstruction primer composition and a sprayer method of applying a thin film of the primer composition to the substrate to be primed, such as steel panels. The reactive polyurethane binder vehicle and the zinc powder are combined with sufficient agitation to produce a substantially uniform slurry. The slurry is filtered to remove agglomerates that would otherwise clog the sprayer nozzles. The curing catalyst may be added to the slurry either before or after filtering. The combined and filtered primer composition is then placed in the sprayer cover pot under constant mild agitation to maintain substantial uniformity.

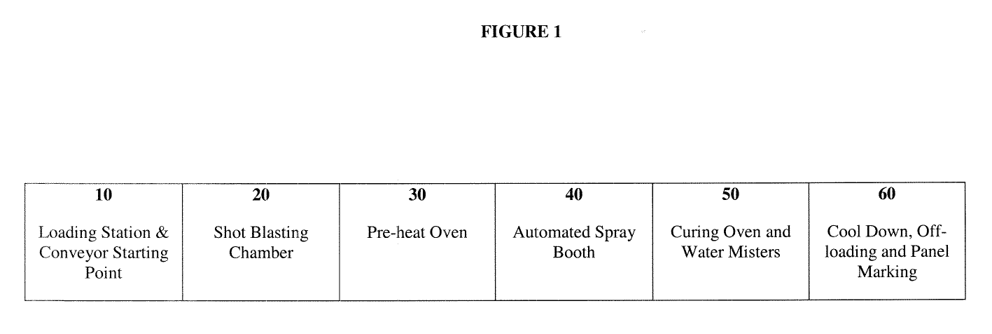

With reference to FIG. 1, the method of application of the preconstruction primer to metal panels comprises loading the metal panel onto a conveyor line at loading station 10, whereby the panel passes through a shot blasting chamber 20 to remove mill scale and prepare the surface for coating with the preconstruction primer. The metal panel then passes into and through the pre-heat oven 30 to raise the temperature of the panel to a range of about 115° F. to about 120° F. The preheated metal panel then passes into the automated spray booth 40 where the metal panel is coated by spraying the zinc-rich preconstruction primer coating composition onto the top surface and edges of the metal panel. After spray coating, the conveyor line then moves the panel into curing oven 50, which includes a plurality of misting jets through which moisture is substantially uniformly introduced into the curing oven to cure the preconstruction primer. In one embodiment, water at a temperature range of approximately 55° F. to approximately 80° F. is substantially uniformly misted around the panel as it passes through the curing oven 50 to cure the primer. In another embodiment, steam is substantially uniformly misted around the panel as it passes through the curing oven 50 to cure the primer. Accordingly, the method is useful in very high humidity environments.

In an embodiment of the invention, the conveyor line moves the metal panel at a rate of about 10 to about 12 feet per minute. The length and temperature of the pre-heat oven 30 are predetermined in order to increase the temperature of the metal panel to a range of about 115° F. to about 120° F. as it is conveyed through the pre-heat oven 30. In one embodiment, the pre-heat oven is an infrared heated oven set at approximately 120° F.

The method of application of the preconstruction primer to metal panels further comprises an automated spray booth 40 whereby the metal panels are spray coated with the preconstruction primer using sprayer equipment known to those skilled in the art to be capable of substantially uniformly spraying high dispersed solid coating compositions. In an embodiment of the invention, the sprayer equipment is set to deliver an amount of preconstruction primer composition that will produce a coating with dry film thickness up to about 1.5 mil. In another embodiment, the metal panels are spray coated to produce a coating with dry film thickness up to about 1.0 mil.

In an embodiment of the invention, the automated spray booth 40 is located from about 10 to about 12 feet from the curing oven 50, such that the panels are conveyed into the curing oven 50 about one (1) minute after being spray coated, and the curing oven 50 is a forced air heated oven set at a temperature of about 175° F. Water mist or steam is provided in curing oven 50 to moisture cure the preconstruction primer composition.

The method of application described above, further includes combining a two component preconstruction primer composition a short time prior to spray application, wherein a first component includes a reactive polyurethane binder composition and the zinc powder, and a second component includes a combination of one or more curing catalysts in aromatic hydrocarbon and aliphatic ketone solvents. In an embodiment of the method, the reactive polyurethane binder composition and zinc powder first component is combined with the curing catalyst second component with sufficient agitation to produce a substantially uniform slurry, and the slurry is then filtered, and the combined and filtered primer composition is then introduced into the sprayer cover pot under constant mild agitation to maintain substantial uniformity.

In another embodiment, the method of application further includes combining a three component preconstruction primer composition a short time prior to spray application, wherein a first component includes a reactive polyurethane binder composition, a second component includes the zinc powder, and a third component includes a combination of one or more curing catalysts in aromatic hydrocarbon and aliphatic ketone solvents.

In one embodiment, the reactive polyurethane binder composition and the zinc powder are combined with sufficient agitation to produce a substantially uniform slurry, the slurry is then filtered, the curing catalyst is then added to the filtered slurry combination, and the combined and filtered primer composition is then placed in the sprayer cover pot under constant mild agitation to maintain substantial uniformity. In an embodiment, substantially continuous agitation is provided using a mechanical stirring apparatus.

In yet another embodiment, the reactive polyurethane binder composition and the zinc powder are combined with sufficient agitation to produce a substantially uniform slurry, the curing catalyst is then added to the slurry combination, and the slurry is then filtered, and the combined and filtered primer composition is then placed in the sprayer cover pot under constant mild agitation to maintain substantial uniformity.

In one embodiment, a three component preconstruction primer composition is combined in a suitable container by combining the zinc powder with the reactive polyurethane binder composition while stirring with an air driven rotary mixer such as a ½ horsepower Cummins #1219 driving a jiffy blade at approximately 450 rpm, and then combining the curing catalyst composition while continuing to stir with the air driven mixer set at approximately 450 rpm to produce a substantially uniform slurry. In another embodiment, agitation is provided by the air driven mixer driving a lift blade at approximately 450 rpm. The substantially uniform slurry is then filtered, and the filtered preconstruction primer composition and the air driven mixer assembly are introduced into a sprayer cover pot under substantially continuous stirring at a rate in the range of approximately 50 rpm to approximately 100 rpm to maintain substantial uniformity.

According to another embodiment of the invention, a primed metal panel suitable for constructing large welded structures such as water tanks suitable for storage of potable water is provided, comprising spray coating of a metal panel in a substantially continuous process with a water cured zinc-rich polyurethane preconstruction primer, the preconstruction primer comprising at least about 51% by weight zinc powder, a urethane pre-polymer binder composition having a plurality of reactive isocyanate groups, and a curing catalyst including a combination of organo-tin and poly-tertiary amine catalysts in an aromatic hydrocarbon and aliphatic ketone solvent system Such primed metal panels have excellent corrosion resistance, and are capable of being welded together for construction of large welded structures such as water tanks suitable for storage of potable water in accordance with NSF standards.

An exemplary example of the primer composition of the invention comprises the following, wherein Part A is prepared in a substantially dry inert atmosphere and packaged in a suitable container, Part B is packaged in a suitable second container, and Part C is prepared and packaged in a suitable third container.

| | EXAMPLE 1 |
|---|---|
| | Percent by Weight |
| | (approximate) |
| Component | |
| PART A Urethane pre-polymer binder composition | 20.45 |
| PART B Zinc dust (lowest lead) | 56.36 |
| PART C Urethane catalyst composition | 23.19 |
| Part C Components | |
| Xylene | 99.06 |
| Acetylacetone | 0.26 |
| Dibutyltin-dilauryl mercaptide | 0.01 |
| Triethylene diamine | 0.67 |
| (about 33% w/w in dipropylene glycol) | |

The application method of the present invention is further illustrated by the following example employing a three component preconstruction primer composition. In an embodiment, the reactive polyurethane binder composition, Part A, is packaged in a two gallon pail caped with nitrogen. The zinc powder, Part B, is packaged in a three and one half gallon pail in a plastic bag. The curing catalyst and diluent composition, Part C, is packaged in a six gallon pail.

### EXAMPLE 2

The preconstruction primer composition is prepared by adding Part A to a six gallon pail. Part B is then slowly and steadily sifted, in a manner to avoid formation of clumps, into Part A while under agitation with an air driven rotary mixer assembly, such as a ½ horsepower Cummins #1219 air mixer driving a jiffy blade, at approximately 450 rpm and the combination is mixed until it is free of lumps and the two components are thoroughly combined. Part C is then slowly and steadily added to the thoroughly mixed Part A and Part B combination and thoroughly combined under agitation with the air driven rotary mixer assembly at approximately 450 rpm. The combined material is then filtered by passing through a fine filter one or more times to remove particulate agglomerates having particle size greater than about 350 mesh, and the filtered material is then transferred into a covered sprayer pot under constant agitation with the air driven rotary mixer assembly operating in the range of approximately 50 rpm to approximately 100 rpm. The suction tube for a Graco, Inc. 33:1 BULLDOG® sprayer is placed in the pot and the pump and lines are loaded with the preconstruction primer. Pump pressure in the range of approximately 1,500 psi to approximately 2,500 psi is set to the lowest pressure necessary to substantially atomize the preconstruction primer. Tips on the automated spray guns can vary depending on the type application. For this application tips 926 and 1227 have been found to be effective. The conveyor line is then started, the line speed is adjusted to run at about 10-12 feet per minute, and a metal panel, or other configuration of substrate, is loaded on the line with an overhead crane. The metal panel then moves through a wheel abrader where it is abraded with steel shot and grit. The metal panel then moves into the infrared pre-heat oven to heat the panel to a range of about 115° F. to about 120° F. The metal panel then moves through the automated spray booth where the top and edges of the panel are coated to yield a dry film thickness of about 0.3 mil to about 1.5 mils. Approximately 1 minute after the metal panel is coated it moves into the post-heat forced air curing oven set at about 175° F., which contains water misters directing water mist in the temperature range of approximately 55° F. to approximately 80° F. to the top and bottom of the panel to cure the preconstruction primer. After the post-heat stage the metal panel moves down the line where it is removed from the line, is turned over and returned to the starting point for processing in the above manner in order to prime all surfaces of the panel. After the post-heat stage of the second coating pass the metal panel moves down the line where it is tagged with job reference and is stacked by an overhead crane.

In accordance with the foregoing example, a fully primed metal panel suitable for constructing large welded structures such as water tanks suitable for storage of potable water is provided, comprising spray coating of all surfaces of the metal panel in a substantially continuous process with a water cured zinc-rich polyurethane preconstruction primer, the preconstruction primer comprising at least about 51% by weight zinc powder, a urethane pre-polymer binder composition having a plurality of reactive isocyanate groups, and a curing catalyst including a combination of organo-tin and polyamine catalysts in an aromatic hydrocarbon and aliphatic ketone solvent system Such primed metal panels have excellent corrosion resistance, and are capable of being welded together for construction of large welded structures such as water tanks suitable for storage of potable water in accordance with NSF standards.

The high zinc level in coating compositions of the invention serves as a sacrificial anode to provide corrosion protection to the primed metal panel, whereby the zinc will be sacrificed before the substrate metal is attacked in the event of damage during transport and erection of the preconstruction panel. Higher zinc levels are required in primers based on organic binders than in primers based on inorganic binders in order to establish an effective anode. Desirable dry film thickness of the applied primer is approximately 1 mil in order to avoid interference with the weldability of the metal panels.

In accordance with the foregoing examples, fully primed steel test panels were welded in configurations including full penetration groove and fillet welds, lap welds, and tee joints, and were inspected for compliance with the AWS D1.1 Structural Steel Welding Code in comparison to similar welded configurations using uncoated steel panels from the same lot of steel plate. The results of the testing showed that coated and uncoated samples performed similarly. The fillet welds in both the lap and tee joints show the same degree of weld penetration and leg size. Destructive or mechanical testing on the buff welds had consistent results, with failures occurring in the base metal region of both coated and uncoated test samples. The plates rejected by radiography showed in line porosity which may or may not be due to coating on the samples. An uncoated sample failed radiography for incomplete fusion, which is attributed to welding technique. Although there were test welds identified as unacceptable, it was determined that the unacceptable welds are attributed to welding technique problems based on the type, size, and locations of the defects. Therefore, the unacceptable welds of primed steel panels was not attributed to the weldable coating. Accordingly, based on the test results, the steel test panels prepared in accordance with the present invention can be used for weldments and will produce acceptable results in accordance with the AWS D1.1 Structural Steel Welding Code.

Adhesion, atmospheric corrosion resistance and immersion corrosion resistance of steel panels coated in accordance with the invention are shown in the following tables, wherein the primer composition of Example 1 was applied by the method of Example 2.

ADHESION -(Freeze Thaw) TTM-58, ASTM-D-3359 Method B
Cross Hatch 5″ × 11″ × 11/16″,
A36 Hot Rolled Steel SP-10

| | |
|---|---|
| Dry Film | 14-Day Cure |

| Thickness | Initial | 5 Wet | 5 Dry | 10 Wet | 10 Dry |
|---|---|---|---|---|---|
| 1.1 mils | 5B | 5B | 5B | 5B | 5B |

SALT-FOG CORROSION TESTING: TTM-011, ASTM B-117
5″ × II″ × ¾″ A-36 Hot Rolled Steel SP-10

| | 14-Day Cure | | | |
|---|---|---|---|---|
| Dry Film | 288 Hours | | | |
| Thickness | S | B | R | |
| 0.3 mil | 10 | 8D | 1G | Discontinued testing after 288 hours. |
| 0.5 mil | 10 | 8D | 1G | |
| 0.8 mil | 10 | 8D | 1G | |

EXTERIOR CORROSION TESTING: TTM-93, ASTM D 1014, ASTM D 1654
ASTM-D-1654 - RATE BLISTERING, RUSTING AND SCRIBE.
4 × 12 A-36 Hot rolled Steel SP-10

| | 14-Day Cure | | | | | | | | | | | |
|---|---|---|---|---|---|---|---|---|---|---|---|---|
| Dry Film | 3-Month | | | 6-Month | | | 9-Month | | | 12-Month | | |
| Thickness | S | B | R | S | B | R | S | B | R | S | B | R |
| 0.5 mil | N/D | 10 | 10 | N/D | 10 | 10 | N/D | 10 | 10 | N/D | 9 | 10 |

EXTERIOR EXPOSURE:
TTM-93, ASTM-D-1014, TTM-005, ASTM-D-610
Large ¾″ Steel Plate

| Dry Film | 1-month | 2-month | 3-month | 6-month | 9-month | 12-month |
|---|---|---|---|---|---|---|
| Thickness | Rust | Rust | Rust | Rust | Rust | Rust |
| 0.62 mil | 10 | 10 | 10 | 10 | 10 | N/D |

Immersion corrosion resistance of steel panels coated with one coat of the zinc primer in accordance with the invention, wherein “P” represents the primer composition of Example 1 was applied by the method of Example 2, and “F” represents two applied coats of finish coating, are shown in the following tables.

IMMERSION: (140 D.I.) TTM-011, ASTM-D-870 Method B
5 × 5 × ¾″ Hot Rolled Steel SP-10

| | | | | 140° F. De-ionized Water | | | | 14-Day Cure | | | | | |
|---|---|---|---|---|---|---|---|---|---|---|---|---|---|
| | | | | 250 HR | | 500 HR | | 1000 HR | | 1500 HR | | 2000 HR | |
| SYSTEM | D.F.T. (mils) | | | B | R | B | R | B | R | B | R | B | R |
| P/F/F | 1.3 | 4.8 | 4.9 | 10 | 10 | 10 | 10 | 10 | 10 | 10 | 10 | 10 | 10 |
| P/F/F | 2.5 | 3.8 | 4.5 | 10 | 10 | 10 | 10 | 10 | 10 | 10 | 10 | 10 | 10 |
| P/F/F | 1.4 | 4.7 | 4.4 | 10 | 10 | 8F | 10 | 8F | 10 | 8F | 10 | 8f | 10 |

IMMERSION: (TAP WATER) TTM-011,
ASTM-D-870 METHOD A
5 × 5 × ¾″ HOT ROLLED STEEL SP-10

| | | | | TAP WATER | | | | 14-Day Cure | | | |
|---|---|---|---|---|---|---|---|---|---|---|---|
| | | | | 3000 HR | | 4344 HR | | 6552 HR | | 8760 HR | |
| SYSTEM | D.F.T. (mils) | | | B | R | B | R | B | R | B | R |
| P/F/F | 1.2 | 4.4 | 4.8 | 8f | 10 | 8f | 10 | 8f | 10 | 8f | 10 |
| P/F/F | 1.1 | 3.9 | 5.7 | 10 | 10 | 10 | 10 | 10 | 10 | 10 | 10 |
| P/F/F | 1.3 | 4.0 | 5.8 | 8f | 10 | 8f | 10 | 8f | 10 | 8f | 10 |

Exposure testing on metal panels with the applied coating composition in accordance with the foregoing examples was conducted under controlled conditions in an independent exposure characterization laboratory (“ECL”) to assess potential airborne releases from the coating during welding and cutting operations. Separate trials were run for each activity (welding and cutting) with both “coated” and “uncoated” steel plates, for a one hour duration in which personnel and area air samples were collected and analyzed. Inside the ECL, a welder equipped with a supplied air respirator/welding helmet performed cutting and welding activities on identically sized steel plates. The welder utilized a flux core welder with continuous feed wire during welding activities, and a plasma torch during cutting activities. Air movement inside the ECL was vented through a HEPA filtration system at a rate of 2000 cubic feet per minute, consistent with OSHA recommendations for welding activities. Air sampling strategy consisted of collection and analysis of 18 samples during each trial for the following: (1) Total Dust & Silica, (2) Repairable Dust & Silica, (3) Isocyanates, (4) Hydrogen Cyanide, (5) Carbon Monoxide, (6) Light and Heavy Organics, (7) Ketones, (8) Amines, and (9) Iron and Zinc. During both welding and cutting activities on the coated steel, area samples indicated total dust concentrations in excess of the American Conference of Industrial Hygienists (“ACGIH”) Threshold Limit Value (“TLV”) of 10 mg/cubic meter and respirable dust concentrations in excess of the ACGIH TLV of 3 mg/cubic meter. Total and respirable silica released during welding and cutting were measured at very low concentrations and did not exceed ACGIH TLVs during this assessment. The elevated nuisance dust concentrations found in the area samples (including total and respirable) are at least partially attributable to the down stream location of the samplers and the potential magnifying effect of those samples being located in the direct flow of the 2000 cubic feet per minute air stream created in the test chamber to mimic the minimal OSHA recommended air flows thus it seems unlikely that the elevated area concentrations of nuisance dust are completely attributable to the coating composition. This is supported by the fact that the relative mass of the applied coating (potential disturbed/released during cutting and welding) is much significantly smaller than the relative mass of the steel lost during the cutting and welding. Isocyanates (specifically MDI and poly MDI) were measured at concentrations substantially lower than the ACGIH TLV of 0.005 ppm in both work area and personnel samples. Hydrogen Cyanide releases for all trials were also substantially below the ACGIH TLV of 4.7 ppm. Light organics released during the assessment were measured at very low concentrations with the following exceptions; carbon disulfide was measured during welding in excess of the ACGIH TLV of 1 mg/cubic meter, and benzene was measured during welding in excess of the ACGIH TLV of 0.5 mg/cubic meter. During both welding and cutting trials, area samples indicated concentrations of iron in excess of the ACGIH TLV of 5 mg/cubic meter, and zinc oxide concentrations in excess of the ACGIH TLV of 2 mg/cubic meter; however, the majority of the iron measured during the assessment is attributable to iron from the cut steel plate. Maximum carbon monoxide measurements obtained during the assessment approached the ACGIH TLV during the welding trial and exceeded the ACGIH TLV during the cutting trial.

The results of the air tests indicate that use of an appropriate respirator, consistent with existing OSHA recommendations for respirator usage during welding and cutting activities, is sufficient to ensure personnel safety when welding and cutting metal plates coated in accordance with the invention.

Although an example of the method is shown using a three component preconstruction primer composition based on a polyurethane binder, zinc powder, and curing catalyst, it will be appreciated that other coating compositions can be used. Also, although the method is useful to prepare primed preconstruction metal panels for use in making welded potable water tanks it can also be used to coat other materials useful in other applications. From the above description of preferred embodiments of the method of the invention, those skilled in the art will perceive improvements, changes and modifications. Such improvements, changes and modifications within the skill of the art are intended to be covered by the appended claims.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A three part corrosion inhibiting preconstruction primer, comprising:
(a) a first part comprising a reactive polyurethane binder composition;
(b) a second part comprising substantially lead free zinc powder;
(c) a third part comprising a curing catalyst composition; and
(d) wherein the three part preconstruction primer is combined a short time prior to spray application, by slowly sifting the second part into the first part with substantially continuous agitation to produce a substantially uniform slurry, combining the third part with the substantially uniform slurry to create a blend, filtering the blend, and introducing the blend into a sprayer cover pot under substantially continuous mild agitation.

2. The preconstruction primer of claim 1, wherein the reactive polyurethane binder composition includes about 8% to about 12% by weight, based on total preconstruction primer composition, of a urethane pre-polymer having a plurality of reactive isocyanate groups.

3. The preconstruction primer of claim 1, wherein the reactive polyurethane binder composition further includes at least one aromatic hydrocarbon solvent, at least one dispersing agent, at least one rheology modifier, at least one inert filler, and at least one pigment.

4. The preconstruction primer of claim 1, further comprising about 51% by weight to about 71% by weight of substantially lead free zinc powder having average particle size such that not less than about 99.8% will pass through a 200 mesh sieve and not less than about 98% will pass through a 325 mesh sieve.

5. The preconstruction primer of claim 1, wherein the curing catalyst composition comprises a combination of organo-tin and polyamine catalysts in aromatic hydrocarbon and aliphatic ketone solvents.

6. The preconstruction primer of claim 5, wherein the organo-tin catalyst comprises up to about 0.01% by weight of dibutyltin-dilauryl mercaptide, the polyamine catalyst comprises up to about 0.23% by weight of triethylene diamine, the aromatic hydrocarbon solvent includes xylene, and the aliphatic ketone solvent includes acetylacetone.

7. A method of preparing a zinc rich preconstruction primer composition for spray application on metal substrates, comprising a two component system wherein a first part includes a combination of a reactive polyurethane binder composition having a plurality of reactive isocyanate groups and substantially lead free zinc powder in an amount sufficient to provide at least about 51% zinc powder in the preconstruction primer composition, and a second part includes a combination of one or more curing catalysts in aromatic hydrocarbon and aliphatic ketone solvents, and wherein the first part and the second part are separately packaged and the preconstruction primer composition is combined a short time prior to spray application, by combining the second part with the first part with substantially continuous agitation to produce a substantially uniform slurry, filtering the resulting substantially uniform slurry, and introducing the filtered substantially uniform slurry into a sprayer cover pot under substantially continuous mild agitation.

8. A method of preparing a zinc rich preconstruction primer composition for spray application on metal substrates, comprising three separately packaged components, wherein a first component includes a reactive polyurethane binder composition having a plurality of reactive isocyanate groups in an aromatic hydrocarbon solvent, a second component includes substantially lead free zinc powder, and a third component includes a combination of one or more curing catalysts in aromatic hydrocarbon and aliphatic ketone solvents, and further comprising combining the three components a short time prior to spray application, by slowly sifting at least about 51% by weight of the second component into up to about 26% by weight of the first component with substantially continuous agitation to produce a substantially uniform slurry, combining up to about 31% by weight of the third component with the substantially uniform slurry, filtering the resulting combined preconstruction primer, and introducing the combined preconstruction primer into a sprayer cover pot under substantially continuous mild agitation.

9. The method according to claim 8, wherein the first component comprises at least about 20% by weight of the preconstruction primer composition, the second component comprises at least about 56% by weight of the preconstruction primer composition, and the third component comprises at least about 23% by weight of the preconstruction primer composition prior to filtration.

10. The method according to claim 8, wherein the preconstruction primer composition is filtered through a filter medium capable of retaining particulate material having particle size greater than about 350 mesh.

11. The method according to claim 10, wherein the preconstruction primer composition comprises a substantially uniform slurry capable of continuous spray application onto a metal substrate.

12. The method according to claim 10, wherein the preconstruction primer composition includes at least about 51% by weight zinc powder after filtration.

13. A method of application of a zinc-rich preconstruction primer to metal panels, comprising: loading a metal panel onto a conveyor line, whereby the metal panel passes through a pre-heat oven to raise the temperature of the metal panel; then through a spray booth where the metal panel is substantially uniformly coated by spraying the zinc-rich preconstruction primer coating composition onto all surfaces of the metal panel; the conveyor line then moves the metal panel into a curing oven, the curing oven also including a plurality of misting jets through which water is substantially uniformly misted around the metal panel as it passes through the curing oven to cure the primer.

14. The method according to claim 13, wherein the conveyor line moves the metal panel at a substantially continuous rate of about 10 to about 12 feet per minute.

15. The method according to claim 13, wherein the temperature of the metal panel is increased to a range of about 115° F. to about 120° F. in the pre-heat oven.

16. The method according to claim 13, wherein the metal panel is spray coated with the preconstruction primer to produce a coating having a dry film thickness up to about 1.5 mil.

17. The method according to claim 13, wherein the metal panel is spray coated with the preconstruction primer to produce a coating having a dry film thickness up to about 1.0 mil.

18. The method according to claim 13, wherein the metal panel is conveyed into the curing oven about one (1) minute after coating.

19. The method according to claim 13, wherein the curing oven temperature is set at about 175° F.

20. The method according to claim 13, further comprising combining a two component preconstruction primer composition a short time prior to spray application, wherein a first component includes a reactive polyurethane binder composition and zinc powder, the zinc powder comprising at least about 51% by weight of the total preconstruction primer composition, and a second component includes a combination of one or more curing catalysts in aromatic hydrocarbon and aliphatic ketone solvents.

21. The method according to claim 20, wherein the reactive polyurethane binder composition and the zinc powder first component is combined with the curing catalyst second component with sufficient agitation to produce a substantially uniform slurry, filtering the substantially uniform slurry, and introducing the combined and filtered preconstruction primer composition into a sprayer cover pot under substantially constant mild agitation to maintain substantial uniformity.

22. The method according to claim 13, further comprising combining a three component preconstruction primer composition a short time prior to spray application, wherein a first component includes a reactive polyurethane binder composition having a plurality of isocyanate groups, a second component comprises at least about 51% by weight low lead zinc powder based on the total preconstruction primer composition, and a third component includes a combination of one or more curing catalysts in aromatic hydrocarbon and aliphatic ketone solvents.

23. The method according to claim 22, wherein the first component and the second component are combined with sufficient agitation to produce a substantially uniform slurry, the third component is then added to the substantially uniform slurry to produce the combined preconstruction primer, filtering the combined preconstruction primer, and then introducing the combined and filtered preconstruction primer into a sprayer cover pot under substantially continuous mild agitation.

24. The method according to claim 23, wherein the conveyor line moves at a substantially continuous rate of about 10 to about 12 feet per minute, the temperature of the metal panel is increased to a range of about 115° F. to about 120° F. in the pre-heat oven, the metal panel is spray coated with the preconstruction primer to produce a dry film thickness up to about 1.0 mil, and the metal panel then passes into the curing oven set at about 175° F., wherein water in a temperature range of approximately 55° F. to approximately 80° F. is substantially uniformly misted around the metal panel as it passes through the curing oven to cure the preconstruction primer.

25. The method according to claim 22, wherein the first component and the second component are combined with sufficient agitation to produce a substantially uniform slurry, filtering the substantially uniform slurry, then combining the third component with the filtered substantially uniform slurry, and introducing the combined and filtered preconstruction primer composition into a sprayer cover pot under substantially constant mild agitation to maintain substantial uniformity.

26. The method according to claim 25, wherein the conveyor line moves at a rate of about 10 to about 12 feet per minute, the conveyor line then moves the metal panel into the pre-heat oven where the temperature of the metal panel is increased to a range of about 115° F. to about 120° F., the conveyor line then moves the metal panel into the spray booth where the metal panel is spray coated with the preconstruction primer to produce a dry film thickness up to about 1.0 mil, and the conveyor line then moves the metal panel into the curing oven set at about 175° F., wherein water in a temperature range of approximately 55° F. to approximately 80° F. is substantially uniformly misted around the metal panel as it passes through the curing oven to cure the primer.

27. A primed metal panel suitable for constructing large welded structures such as water tanks suitable for storage of potable water, comprising spray coating of all surfaces of the metal panel in a substantially continuous process with a water curable zinc-rich polyurethane preconstruction primer, the preconstruction primer comprising at least about 51% by weight zinc powder, a urethane pre-polymer binder composition having a plurality of reactive isocyanate groups, and a curing catalyst including a combination of organo-tin and polyamine catalysts in an aromatic hydrocarbon and aliphatic ketone solvent system.

28. The primed metal panel of claim 27 whereby the primer coating on the primed metal panel has a dry film thickness in the range of approximately 0.3 mils to approximately 1.5 mils.

29. The primed metal panel of claim 27 whereby the primed metal panel has excellent corrosion resistance, and is capable of being welded for construction of large welded structures such as water tanks suitable for storage of potable water in accordance with NSF standards.
